(19) United States
(12) Patent Application Publication
(10) Pub. No.: US 2021/0158714 A1
(43) Pub. Date: May 27, 2021

(54) Method and Apparatus for Inquiry Driven Learning

(71) Applicant: Beagle Learning LLC, Paradise Valley, AZ (US)

(72) Inventors: Turner Kolbe Bohlen, Yakima, WA (US); Linda Tarbox Elkins-Tanton, Paradise Valley, AZ (US); James Stuart Tanton, Paradise Valley, AZ (US)

(21) Appl. No.: 17/169,024

(22) Filed: Feb. 5, 2021

Related U.S. Application Data
(63) Continuation of application No. 15/622,467, filed on Jun. 14, 2017.
(60) Provisional application No. 62/350,148, filed on Jun. 14, 2016.

(51) Int. Cl. G09B 7/077; G09B 7/02; G09B 5/12; G09B 5/02

(52) U.S. Cl. CPC G09B 7/077; G09B 5/02; G09B 5/12; G09B 7/02

(57) ABSTRACT

Systems and methods are provided for implementing inquiry-driven presentation of an online educational course. Course content may be illustrated as a course map having multiple content nodes interconnected by indicia of questions relating an originating content node with a destination content node. After consuming course content associated with a node, participants may specify a question concerning the content. The participant's specified question is used to determine the next portion of course content presented to the participant. Participants may frame new questions, which may be linked to existing content nodes or new content nodes. A participant's interaction with, and progression through, a course map may be utilized to assess the quality of a participant's activities.

### RELATED APPLICATIONS AND CLAIM OF PRIORITY

This patent application is a Continuation patent application of and claims priority to U.S. patent application Ser. No. 15/622,467 filed on Jun. 14, 2017, entitled Method and Apparatus for Inquiry Driven Learning, which claims priority to, and incorporates by reference, U.S. provisional patent application 62/350,148, titled: Method and Apparatus for Inquiry Driven Learning, which was filed on Jun. 14, 2016.

### TECHNICAL FIELD

The present disclosure relates in general to technology-enabled learning, and in particular to platforms, tools and methods for inquiry driven learning.

### BACKGROUND

Many traditional techniques for education emphasize memorization of facts and information. However, facts change, and with our increasing access to information, such as via the prevalence of network-connected devices, memorization is becoming decreasingly important. Meanwhile, for many students, rigid predefined lesson plans commonly implemented in traditional education environments may stifle the exploration of student curiosity and decrease student engagement.

Inquiry-based learning techniques have been demonstrated to be effective in teaching new material to students, while increasing student engagement in the subject matter and, importantly, simultaneously improving student skills in information processing and problem-solving. However, incorporating inquiry-based learning techniques into formal education environments can present several challenges. The student-driven nature of subject matter coverage creates challenges with measuring student progress, and documenting and verifying the scope of subject matter coverage. Administering a course in an inquiry-driven manner may also require different and/or additional teacher training, preparation and expertise relative to traditional content presentation methods.

### SUMMARY

Embodiments of the present invention can be utilized to implement a computer-implemented technology platform for interactive learning that make inquiry driven and student-centric learning methodologies more accessible, and better-suited to formal education environments. Further, course design methodologies are provided for effectively designing content to be presented via the inquiry-driven learning platform.

In accordance with one aspect, systems and methods are provided for administering an education course to one or more course participants. The method may include rendering, for each course participant, on a personal electronic device display screen, a course map. The course map can include multiple interconnected content nodes, each associated with a portion of course content. Course content associated with a content node may be presented via the user's personal electronic device, e.g. upon selection of the associated content node. Upon presentation of course content, the course participant may be queried for a participant question responsive to the course content last consumed. In some circumstances, course participants may select from one or more predetermined questions concerning the course content. In some circumstances, participants may frame questions in their own words; the participant may then be presented with options most closely matching their question, and/or linked directly to other content nodes believed to be responsive the participant's question. Based in whole or in part on the participant's question, course content associated with another, linked content node is displayed. Content nodes associated with already-viewed course content may be differentiated visually from un-viewed content nodes in the course map, via application of different styles.

Participant questions may be displayed on a course map in various ways, typically interconnecting a content node regarding which the question is posed, with a subsequent content node having content responsive to the question. In some embodiments, potential participant questions may be displayed as lines interconnecting two nodes. In some embodiments, questions may be rendered as nodes themselves, preferably distinguished visually from content nodes.

Visualization and tracking tools are provided to measure student progress through material, and provide students with feedback and context for their learning activities. For example, attributes indicative of a course participant's interaction with a course map may be transmitted to, and aggregated by, a network-connected server. Course participant assessments may then be derived by, e.g., categorizing each participant's course map interactions.

Various mechanisms may also be provided to permit students to interactively supplement and modify course content as they consume it. For example, a participant may frame a new question, differing from previously-configured questions responsive to a particular portion of course content. A report may be generated and transmitted to a course administrator, identifying the new question for uploading of additional course content responsive to the new question. In some circumstances, a participant's new question may be made available to other course participants for feedback, such as upvoting or endorsement. Reporting of new questions to a course administrator may then be ranked and/or filtered based on feedback from course participants.

Content for a course map may be generated in a number of ways. Unbundling of course content may provide course designers with enhanced flexibility. In some embodiments, a course administrator may select a digital course content node bundle from amongst a plurality of node bundles made available by a network-connected course content repository. Content from selected node bundles may be incorporated into a course map, e.g. via linking with other content nodes.

These and other aspects may be implemented in certain embodiments described hereinbelow.

### BRIEF DESCRIPTION OF THE DRAWINGS

FIG. 1 is a schematic block diagram of an online inquiry-driven learning.

FIG. 2A is a course map with nodes rendered in a first style.

FIG. 2B is a course map rendered in a second set of styles.

FIG. 2C is a user interface for developing a course map with multiple sections.

FIG. 2D is a user interface rendering of a portion of a course map with multiple sections.

FIG. 3 is a process diagram for building a course map.

FIG. 4A is a process for administering a course map.

FIG. 4B is a schematic block diagram of variable course participant question submission modalities.

FIG. 5 is a user interface for initiating a course map.

FIG. 6 is a user interface with mechanisms for user response to content.

FIG. 7A is a user interface for submission of a new question.

FIG. 7B is a user interface facilitating new question submission and consideration of other participant questions.

FIGS. 8,9 and 10 are user interfaces for responding to presentation of a content item.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Computing Environment

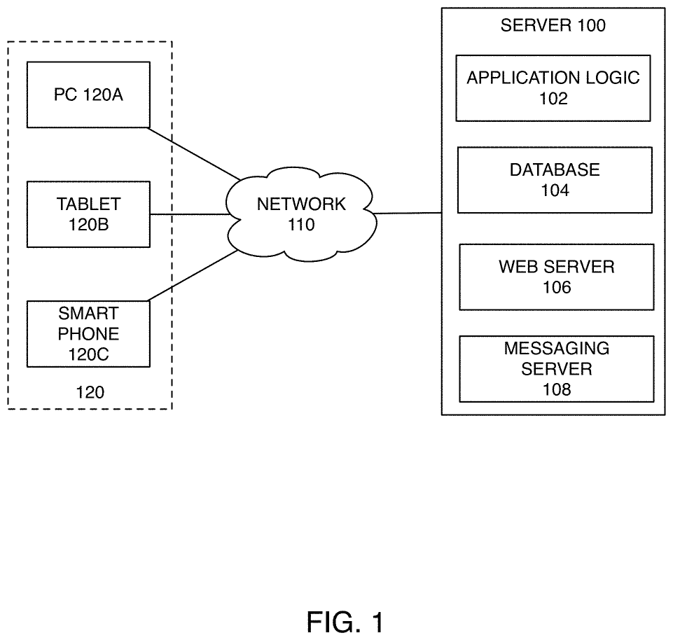

FIG. 1 is schematic block diagram of a computing environment that may be effectively utilized to implement certain embodiments of the platform and methods described herein. Server 100 communicates, inter alia, via computer network 110, which may include the Internet, with user personal electronic devices 120 such as personal computer 120A, tablet computer 120B, smart phone 120C and smart watch 120D. While FIG. 1 illustrates four exemplary user devices, it is contemplated and understood that implementations may include large numbers of user devices. For example, some implementations may include user devices of different types for each of many individuals around the world.

Server 100 implements application logic 102, and operates to store information within, and retrieve information from, database 104. The term “database” is used herein broadly to refer to a store of data, whether structured or not, including without limitation relational databases, document databases and graph databases. Web server 106 hosts one or more Internet web sites enabling outside user interaction with, amongst other things, application logic 102 and database 104. Messaging server 108 enables instant messaging, such as SMS or MMS communications, between server 100 and user devices 120.

While depicted in the schematic block diagram of FIG. 1 as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. For example, in some embodiments, components and functionality of server 100 may be distributed between a primary web application and a network-accessible API. That said, implementations will typically include at some level one or more physical servers, at least one of the physical servers having one or more microprocessors and digital memory for, inter alia, storing instructions which, when executed by the processor, cause the server to perform methods and operations described herein.

Interactive Map-Based Course Architecture

At the outset, course content is typically developed for implementation by, e.g., server 100 and an associated content presentation platform. A content expert may act as a course designer, using the platform to create more effective learning experiences. Course content can be embodied in maps. For example, a course designer may then work with a group of volunteers using design thinking processes to assemble associated content items, and test each piece of content for accessibility and to generate natural next questions. The content items and natural next questions can then be organized into a map or directed graph.

Specifically, courses can be structured into a map having multiple interconnected nodes. Each node is associated with course content, such as videos, articles, posts, graphs, images and/or in-person experiences. Content associated with nodes can be stored by database 104 and presented to user devices 120 via network 110. For example, in some embodiments, content items may be presented via a web browser application operating on PC 120A, accessing a web application hosted by web server 106 to present content items stored within database 104. In some embodiments, tablet 120B and smartphone 120C may execute applications installed locally on those devices, which interactively access server 100 and content stored thereon via network 110. In some embodiments, course content may be downloaded or otherwise installed locally on a user device 120 prior to use.

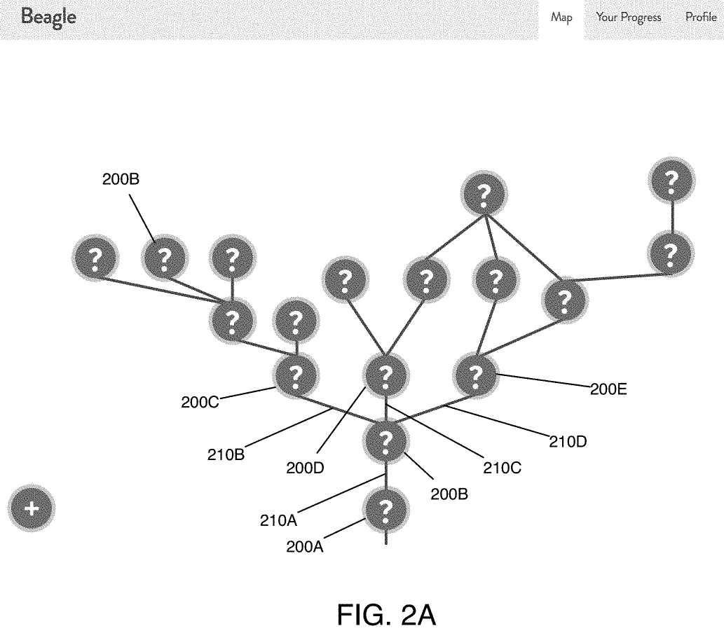

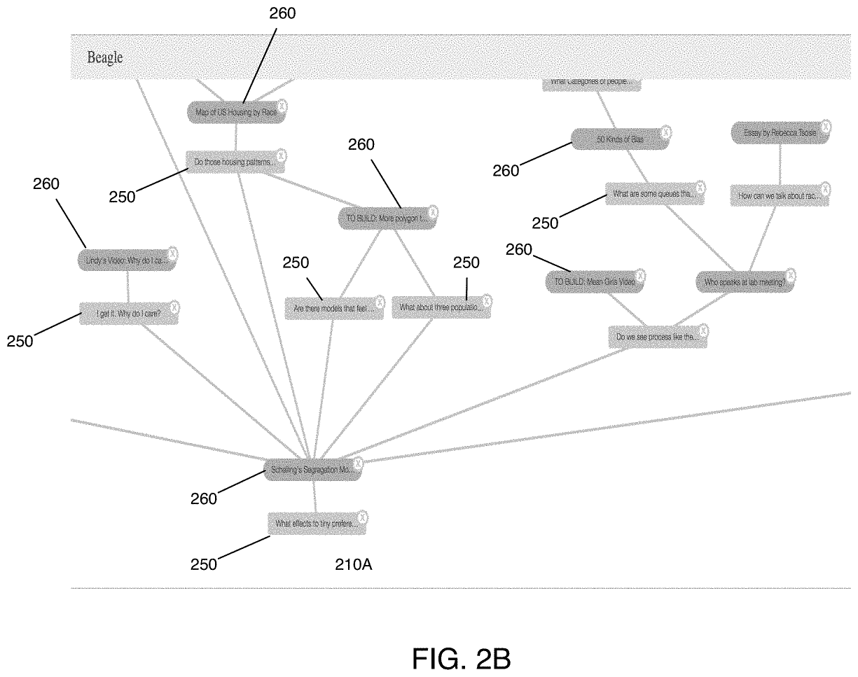

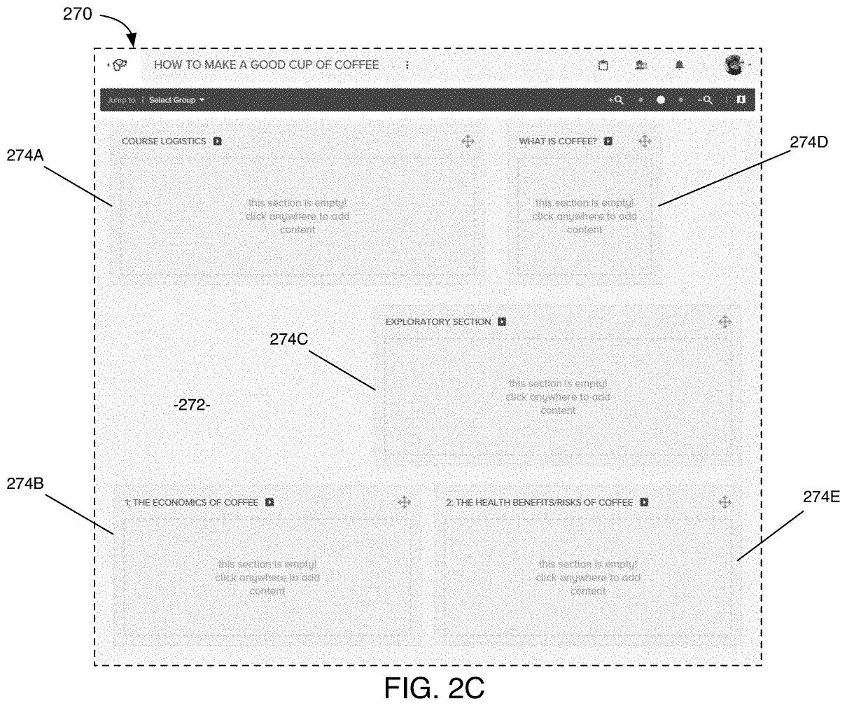

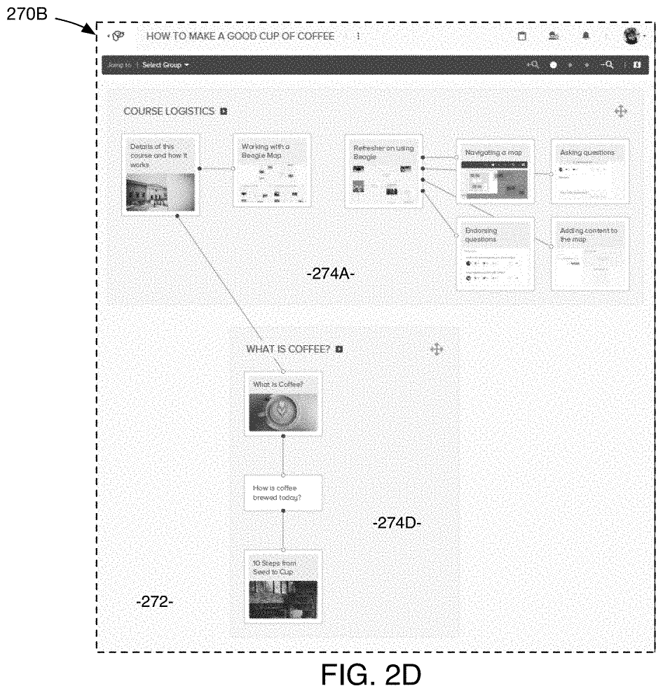

Nodes may be connected by, e.g., natural next questions, or other functional transition components such as a direct, automated transition between nodes or a prompt for other types of user interaction. FIG. 2A illustrates an exemplary course map, as may be viewed by a user having not yet begun the course. Circular indicia, such as indicia 200A, 200B et seq., represent nodes, or portions of the course content. Nodes associated with course content that has previously been rendered to a course participant, may be differentiated visually by style from course content that has not yet been viewed. For example, the question mark embedded in each node of FIG. 2A indicates that the content node has not yet been accessed by a student; thus, FIG. 2A represents a course view for a student who has not yet begun a course. In other embodiments, some or all of the course map questions and/or content items may be revealed to a student, even before the student accesses the association portions of the course. Each content node is interconnected by connector segments (e.g. segments 210A, 210B et seq.) representing, in the embodiment of FIG. 2A, a natural next question.

A beginning node 200A serves as a student's first encounter with the map. After viewing and interacting with the content associated with that node, the user follows any of one or more natural next questions to a new content node, preferably containing a new piece of content related to the question that was chosen to access that node. For example, node 200A includes a single natural next question 210A, leading to presentation of content associated with node 2008. At that point, if the user then asks question 210B, the user is presented with content associated with node 200C. Alternatively, if the user asks question 210C, the user is presented with content associated with node 200D. If the user asks question 210D, the user is presented with content associated with node 200E. In some embodiments, users may also ask their own questions; as described further below, submission of a new question may serve as a mechanism to supplement or improve a course map, such as by a course administrator, teaching assistant and/or fellow student adding new content responsive to the new question.

In some embodiments, the natural next questions from each node—ones preferably tested during course design to indeed be questions that users naturally ask in response to the content of that node—are revealed to the user only after the content has been examined. The map is thus slowly revealed to the user as the user explores the topic. The user is following an exploration of the topic through a path of his or her own design. Meanwhile, the platform (i.e. server 100) keeps track of the user's journey through the map so that the user can backtrack and follow alternative paths in any manner desired. In other embodiments, a course map may be revealed to a student in its entirety, providing the student with context for their work to date. In yet other embodiments, predetermined subsets of the map may be revealed to students at various times, providing instructors and/or the software platform implementing the map, to control map presentation as student proceed through the material.

Other embodiments of course maps or directed graphs may be utilized. For example, FIG. 2B illustrates an alternative course map, in which questions and content items are both visualized as nodes, with the type of node differentiated visually by style (e.g. color and shape). Rectangular nodes 250 represent questions, while rounded nodes 260 represent content.

In some embodiments, maps may be divided up into sections. Each section may be composed of a grouping of interconnected nodes. In some course mappings, nodes within a section may be related to one another by subject matter. In some mappings, nodes within a section may be selected such that the amount of material in the section (or the anticipated time to consume the materials) falls within a target range. Thus, course map sections may be used as a non-linear equivalent of lectures in traditional courses.

FIG. 2C illustrates a user interface of a course map builder 270, facilitating preparation of a course map having multiple sections by a course administrator. Course map 272 is configured with five course map sections 274A, 2748, 274C, 274D and 274E. Content nodes may be specified within each course map section 274, and linked by connecting questions. FIG. 2D illustrates a user interface display 2708 showing a portion of course map 272, in which course map sections 274A and 274D have been populated with multiple content nodes, interconnected by various responsive questions. Processes for developing course material are described further below.

Course Design

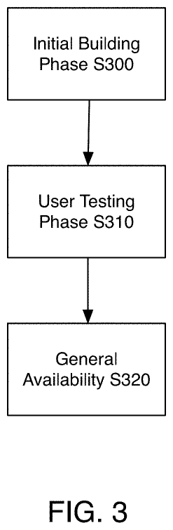

FIG. 3 illustrates an exemplary process for developing content for the platform. In step S300, an initial building phase is undertaken. In step S310, a user testing phase is implemented. In step S320, the course is made generally available.

In some embodiments, initial building phase S300 can be implemented using the following steps:

1. Preliminary Step: Articulate the overarching question for the map topic.

2. Preliminary Step: Articulate the common characteristics of the intended user group. E.g., How old is the typical user? What is the typical background education of the user? What beliefs might the user already hold about the topic? Where does the typical user work or go to school? Where did he or she grow up? What does he do in their free time? What are her aspirations? What does he worry about? What does her average day look like? The course designer may write a summary of the envisioned user(s) sufficiently detailed so that the course designer can “put themselves in the user's shoes.”

3. Preparatory Step: Interview a minimum of 5 potential users—people similar to those who would use the map once it is built. The course designer can observe user responses to the content, such as: What are their first questions about the topic? Their emotional reactions? Are they interested in learning about it? What have they already seen on the subject? Do they have any favorite resources? Interviews should be planned in advance with a list of questions to start the interview off and an established method for documenting the interview.

4. Preparatory Step: Bring together a small group of content experts (e.g. 2-6 individuals having expertise in the subject matter of a course) to brainstorm a rough initial list of content pieces that attend to the overarching question. One goal here is to collate as much relevant content as possible. Begin to identify the key content pieces/issues that the the user should encounter. Preferably, node content will satisfy criteria such as: inspires an emotional response (i.e. is not “mundane”); inspires an intellectual response (i.e. inspires thought and natural next questions); and is publicly accessible. In some circumstances, it may be desirable for course designers to create node content themselves.

5. Preparatory Step: Identify a possible Seed Content Node, sufficiently accessible, broad, and intriguing to evoke natural next questions. Have the expert team attempt to organize the content into a map loosely fitting the node map format. What learning paths seem to lie within the identified content? What natural next questions might link content topics? This map will typically change considerably after user testing.

At this point, the resulting base of content for the map can be subjected to user testing (step S310). User testing may include, in an exemplary embodiment:

1. Have a minimum of three potential users view the chosen seed content piece. Ask them about their emotional reaction to the piece (interesting?intriguing? off-putting? overwhelming?) and what their natural next questions about the piece are. Reveal your selected natural questions and ask the potential users about their reactions to those too, and which they would likely follow.

2. Adjust the seed content appropriately and set of natural next questions. Retest if there is a change of content and/or questions, and rebuild the draft map.

At this point, a content map builder may enter an iterative cycle of building, testing and rebuilding the map. In some embodiments, the iterative cycle may include three steps:

1. Have one or more learners (preferably, at least three) progress through the map, just as they would if the map were deployed for general availability via, e.g., a web site hosted by web server 106. Issues to be evaluated during this step may include: What questions did the users want to ask that were not available? What content was the least and most exciting to them? What was their emotional reaction to each piece of content they visited? Which paths in the map were most popular? Which were ignored?

2. Develop hypotheses on how to improve the map. Preferably, an experience using the course map encourages users to stay engaged and always want to come back and ask one more question. One objective of using the course map is to avoid leading a user to a preset opinion or position; philosophically, the desired user experience is not necessarily finitely contained, but may rather focus on provoking the user to always have a natural next question. A goal of a course map may be to help a user formulate his or her own opinion on the topic, one they feel they can explain and defend, be willing to modify in the face of new evidence, and so always willing to re-examine and question.

3. Redesign the map with these hypotheses in mind and retest. Preferably, each and every question and content item is tested. If certain paths of the draft map are ignored, this may be an indication that those paths should be removed from the map.

When all content pieces have been reviewed and the interviews are primarily positive, the map may be deemed ready for release to the public (step S320).

In some embodiments, it may be desirable to incorporate a mechanism for evaluating student progress and level of interaction with the course materials. In such embodiments, course design processes may further include assignment of points to various content nodes, questions and/or interactions with the map. The points may then be utilized to develop a score or rating for each student using the map.

Course Implementation Platform

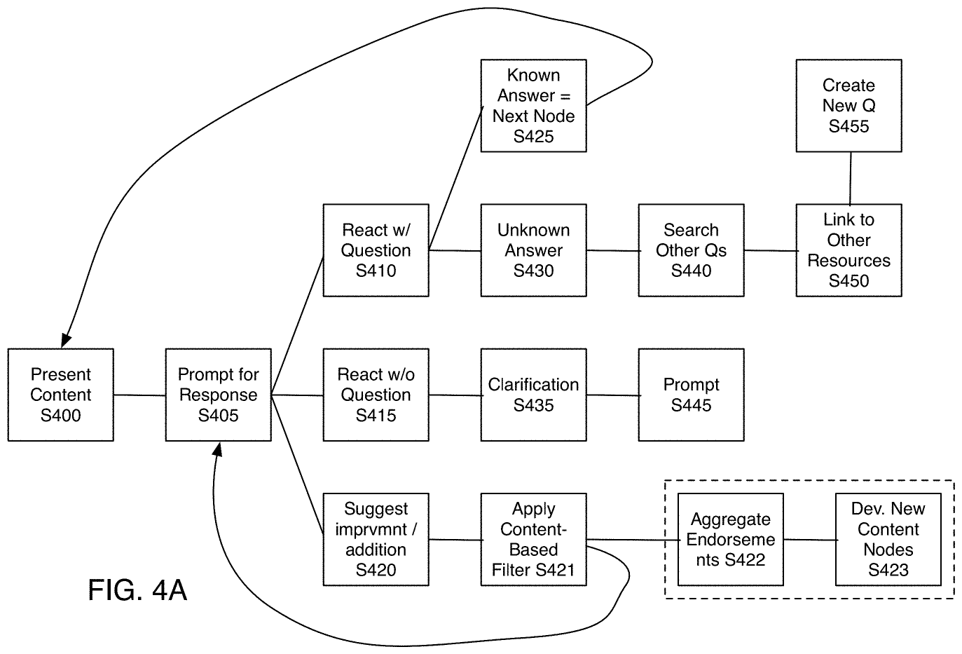

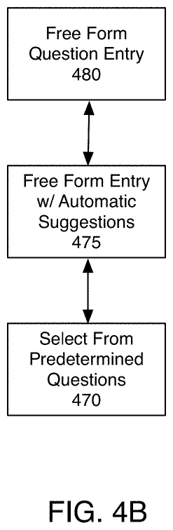

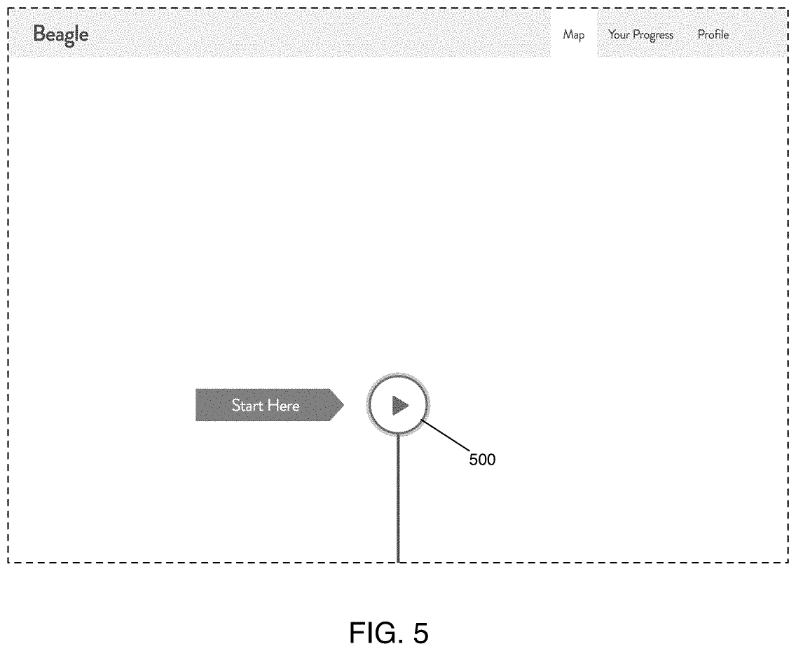

In some embodiments, course maps can be implemented using an online content administration platform hosted via, e.g., server 100. FIG. 4A illustrates an exemplary process for administering a course map. In step S400, a content item is presented to the user. FIG. 5 illustrates an exemplary user interface that may be presented to a user in anticipation of presenting an initial seed node content item. Specifically, seed content node 500 is presented to the user. Selection of node 500 (e.g. clicking the node in a web browser UI, or tapping the node in a mobile or tablet app UI) initiates presentation of associated portions of course content (described further below).

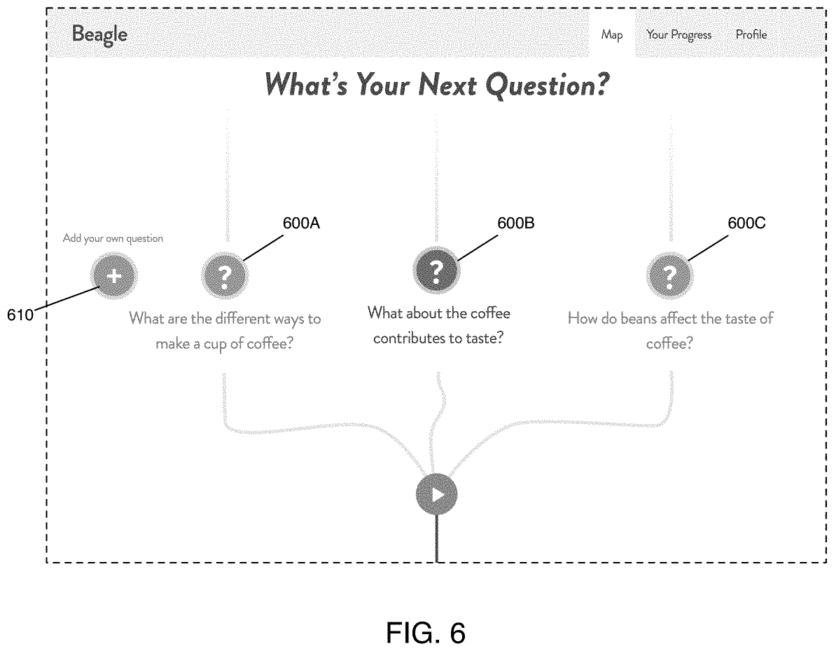

After presentation of the associated content portions, the user is queried for a response (step S405). FIG. 6 illustrates an exemplary user interface for querying a user for a next question, in response to presentation of a seed node 500 content. The user may react with a known question (step S410), in which case the user is presented with further content items associated with the next node, linked by the user's selected question (step S425). In some embodiments, a user interface may be provided suggesting one or more options for next questions that may be selected; for example, in the embodiment of FIG. 6, the user may select an indicium associated with one or more predetermined next question options 600A, 600B or 600C, and the process repeats back to present new content.

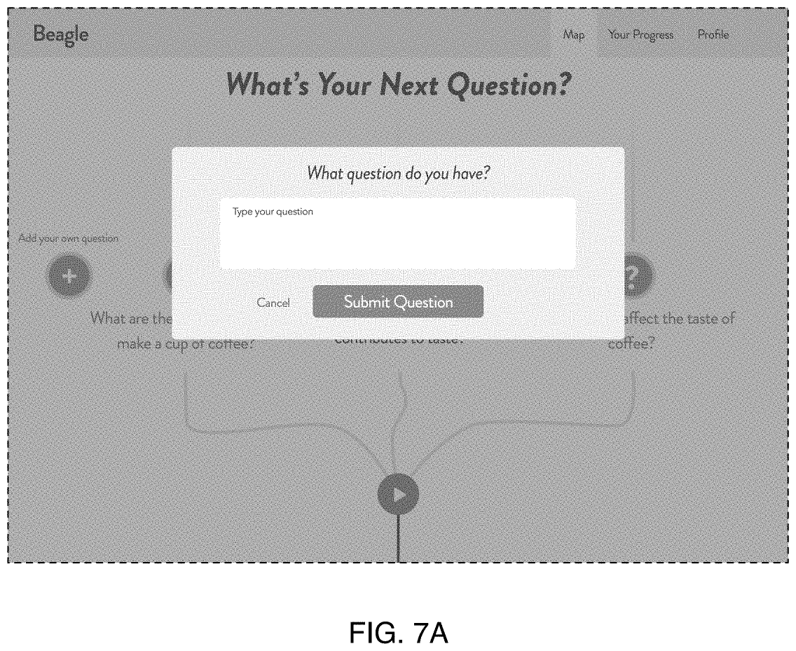

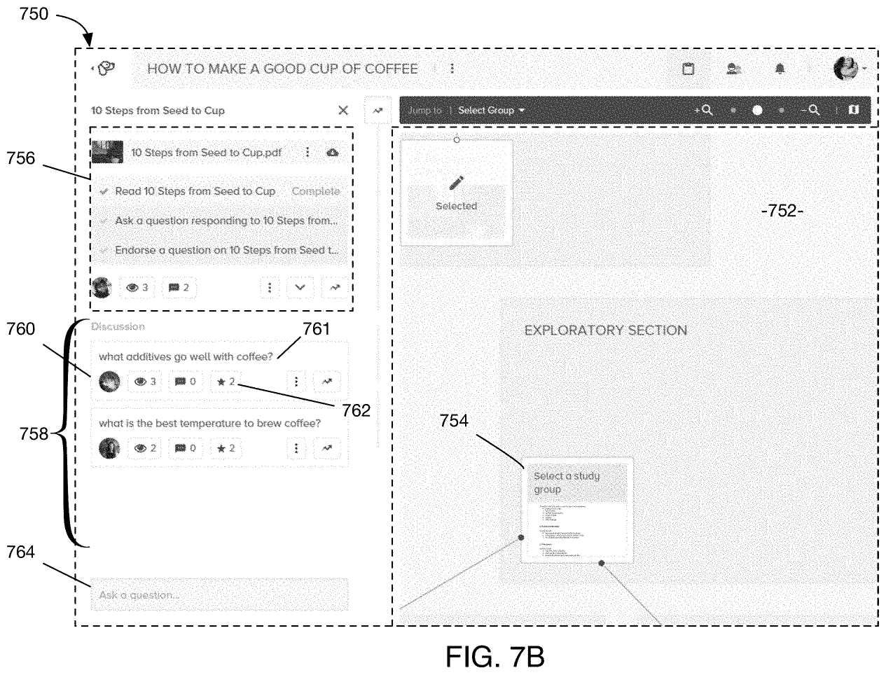

Students may also be provided with mechanisms through which they may improve or supplement the course map, e.g. via submission of new questions not previously built into the course (step S420). In the embodiment of FIG. 6, presenting predetermined question options, new question indicia 610 is provided to enable a user to submit a new question associated with the current content node. FIG. 7A illustrates an exemplary user interface enabling submission of a new question within a text entry field.

Various mechanisms may be implemented for handling new questions. In some embodiments, it may be desirable for platform application logic to undertake an initial automated evaluation of the extent to which a new question may be answered by some other piece of content already within a course map. Such a mechanism may be helpful in minimizing addition of duplicative questions and content within a course map. For example, in step S421, text content within a new question submitted in step S420 may be utilized by a content-based filter to select a subset of course content nodes believed to be helpful in answering the new question. The selected subset of content nodes may then be presented to the user for consideration (e.g. via an interrogatory modal rendered on a user device 120 via interaction with server 100), before finalizing submission of the new question. The content-based filter may incorporate machine learning components in an effort to continually optimize matching of user-submitted questions with pre-existing course content. For example, a user may be queried for feedback concerning whether a content item recommended by the content-based filter satisfactorily answers the user's question; the user's response to that query may then be applied as feedback in a supervised machine learning mechanism to optimize parameters of the content-based filter.

Once finally submitted, the student may be prompted to select another question, in order to continue exploring the existing course content (step S405). Meanwhile, content responsive to the new question may subsequently be uploaded to create a new course node (step S423). New questions may be queued for another entity or individual (such as a course administrator, teacher or teaching assistant) to locate and upload appropriate content responsive to the new question, at which time the course map may be supplemented using course administration tools implemented by server 100 to add a corresponding node and linking question to the course map. Additionally or alternatively, the question may be shared with other course participants, and another student can suggest responsive content. A student may also be permitted to find responsive content and answer the question themselves. By permitting one or more users to contribute new questions, and/or source new responsive content, a course can be continuously developed and improved as it is administered.

Developing (or auditing the quality of) new content nodes responsive to newly-submitted questions may require a significant investment in time on the part of a teacher or teaching assistant. Therefore, it may be desirable to implement a mechanism to assess the significance or importance of newly-submitted questions. Once such embodiment renders newly-submitted questions to other students with a user interface indicium for endorsing or “upvoting” the question (step S422). Course instructors and their assistants may then prioritize new questions for development or confirmation of responsive content, based at least in part on the number of endorsements relative to other new questions (step S423).

In some embodiments, a multi-stage process may be utilized to solicit new questions from course participants and generate new course map content based thereon. In an initial stage, a newly-submitted question may first be posed as a comment, associated with a previously-existing content node to which the question pertains. The question may be made available for consideration by individuals viewing the content node to which the question pertains, but may not be otherwise displayed on the course map.

FIG. 7B illustrates another exemplary user interface display that may be rendered on a display screen of a personal electronic device 120, facilitating both question submission and consideration of questions by other course participants. User interface display 750 includes course map pane 752, in which a portion of the course map may be displayed. Course map pane 752 includes node 754, associated with course content with which the user of display 750 is currently interacting. Node interaction pane 756 provides, amongst other things, course participant queues for desired interactions of a course participant with node course content. Discussion portion 758 provides indicia of questions asked by course participants relative to course content associated with node 754, including question indicium 760. Question indicium 760 includes question content 761, and upvote indicium 762. Upvote indicium 762 may be selected to indicate participant interest in, or approval of, question 761. Display further includes new question submission field 764, via which a user may enter a new question, which may be added to discussion portion 758 and commented on and/or endorsed by other course participants. User interaction with elements of display 750 may be conveyed to server 100 for storage and reporting, amongst other operations.

Participant questions, along with course participant upvotes or other feedback concerning the question, may also be made available to a teacher, teaching assistant, course designer or other course administrator. The course administrator may then consider each question and feedback thereon, and select some or all of the questions to be moved out onto the course map. Thereafter, the selected participant-submitted questions may be reflected on the course map, such as via further question nodes 250 in the course map of FIG. 2B. The new question nodes may then be interconnected with an existing content node 260, or a new content node 260 may be developed, e.g. via research conducted to answer the question.

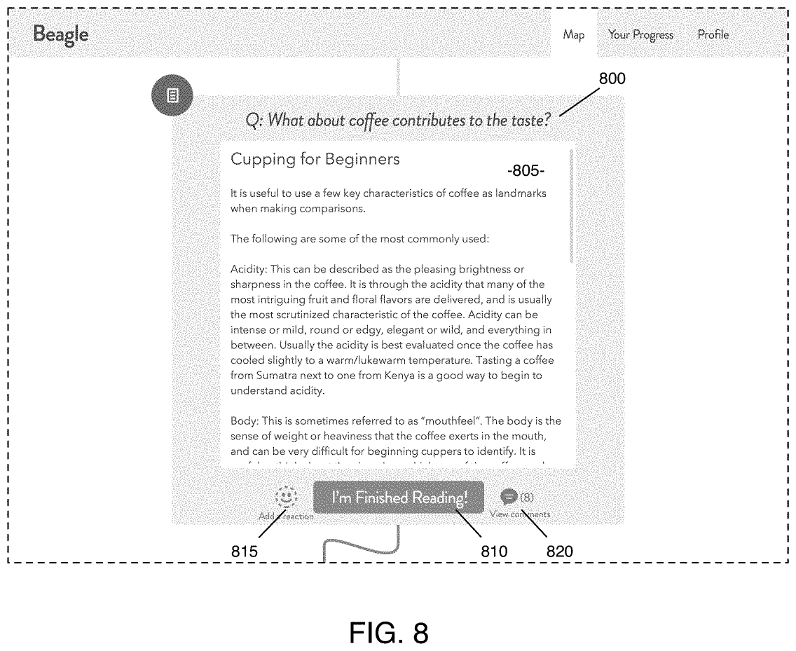

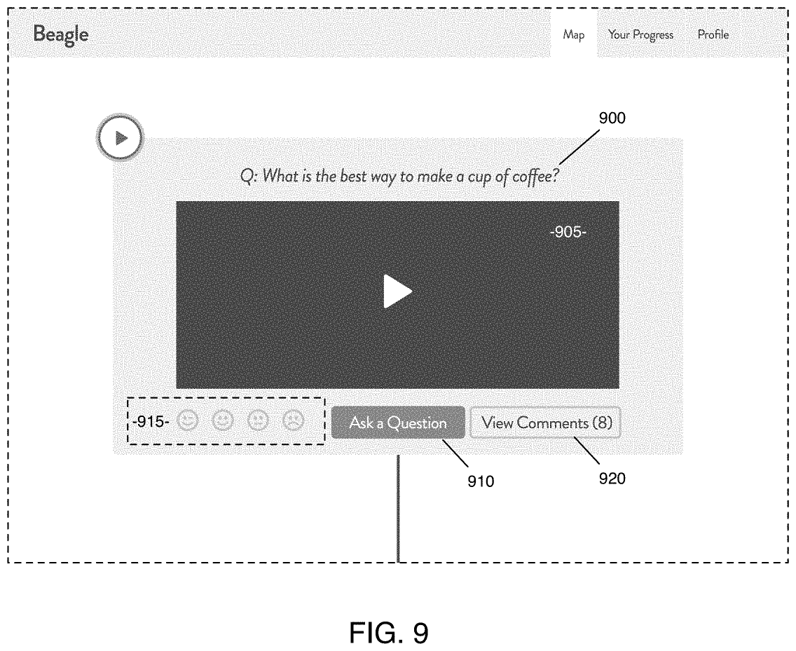

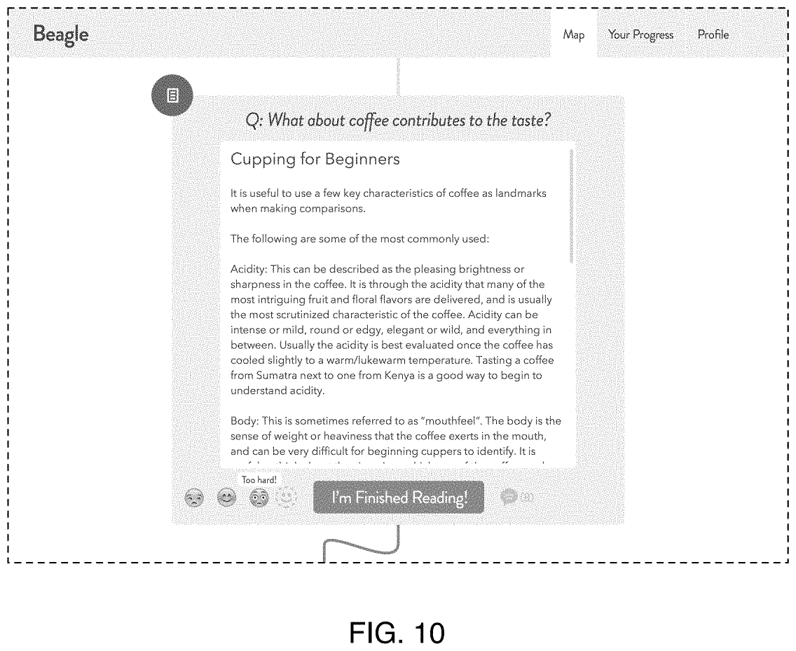

Users may also be provided with tools to convey reaction to content, other than submitting a next question (step S415). FIG. 8 illustrates an exemplary user interface. Header 800 indicates the question asked, which led to presentation of content 805. Button 810 provides a mechanism for users to indicate that they are done viewing the present content. Selection of Add Reaction indicia 815 enables a user to convey one or more indications of their emotional state upon consuming content 805. View Comments indicia 820 enables a user to view comments submitted by other users in connection with content item 805.

FIG. 9 illustrates another exemplary user interface that may be presented to a user in response to providing content in step S400. Header 900 indicates the question asked, which led to presentation of content 905. Button 910 provides a mechanism for users to ask a Next Question (step S410). Multiple selectable Reaction indicia 915 enable a user to convey one or more indications of their emotional state upon consuming content 905. View Comments indicia 920 enables a user to view comments submitted by other users in connection with content item 905. FIG. 10 illustrates another exemplary user interface that may be presented to a user in connection with presentation of content items, in which the user has submitted three Reactions in response to the content. In some embodiments, users may additionally or alternatively be prompted to consider new questions submitted by other students, and endorse (or “upvote”) questions for which they are most interested in learning an answer (as described above in connection with step S422).

Some embodiments described above prompt students with one or more predetermined questions associated with each item of presented content. However, in some embodiments, it may be desirable to prompt students to frame (or attempt to frame) their own questions. For example, a user may be initially presented with a user interface element rendered on personal electronic device 120, via which the user may submit a question in response to the portion of course content most recently presented to them, with the question framed in their own words. Examples of such user interface elements include, in some embodiments, a freeform text entry field rendered directly on personal electronic device 120. In other embodiments, it may be desirable to implement a speech recognition component enabling a course participant to frame a question verbally; such an embodiment may be implemented via, e.g., a local microphone function integrated within personal electronic device 120 interacting with a network-connected speech recognition component implemented via server 100 or a third party network-connected system such as the Google Cloud Speech API, returning a text-based interpretation of the verbally-framed question for further analysis. Once submitted, the question may then be interpreted (e.g. by server 100 or locally on device 120) towards identifying a responsive content node. User question interpretation may involve, for example, comparison of submitted question content to lists of predetermined questions, after submission and/or as a user begins entering their question, with the user ultimately selecting a predetermined question most closely matching the question framed by the user.

In some embodiments, it may be desirable to shift the user between question entry modalities based on, e.g., the user's usage of the application and/or performance. For example, users may be presented with decreasingly structured question entry modalities as the time or success with which they interact with the application increases. Similarly, users having difficulty framing questions given a current question entry modality may be presented with increasingly structured modalities for question entry until they are effectively navigating the course map. FIG. 4B illustrates an exemplary sequence of question entry modalities through which a user may be cycled. Initially, a user may be presented with question entry modality 470 following presentation of course node content, via which a user selects from amongst a list of predetermined questions. After completion of threshold amount of course activity (e.g. viewing course content from a predetermined number of nodes and selecting questions to initiate presentation of further nodes), the question entry modality via which the user interacts with personal electronic device 120 may shift to modality 475, via which the user frames questions in their own words and is presented with suggestions from amongst predetermined questions during entry of each question. After completion of a second threshold of course activity using question entry modality 475, the question entry modality via which the user interacts with personal electronic device 120 may shift to modality 480, via which the user frames questions in their own words, without suggestions during entry.

In some embodiments, it may be desirable for application logic 102 to implement course activity benchmarks against which a user's participation may be periodically evaluated. Server 100 may one or more participant activity benchmarks over time in order to perform course-specific participant evaluations. Such activity benchmarking mechanisms may be useful for pacing a class, particularly to the extent that course activities are largely or wholly performed outside of a live classroom, on the participant's own time. Examples of activity benchmarks that may be implemented in some embodiments include, without limitations, one or more of: (a) a minimum number of content nodes with which a participant interacts in a given time period; (b) a course section that must be completed before a given deadline; (c) a minimum number of questions that a student must ask during a given time period; and (d) a minimum number of question endorsements a student must submit during a given time period. These and other metrics, in various combinations and permutations, may be applied for pacing of a course implemented using the systems and methods described herein.

Various metrics concerning course utilization and user interaction with course content may also be used for iterative course improvement after a course is run. Metrics describing course utilization and/or user interaction with course content (such as what questions are asked, who views which questions and content, how many upvotes questions receive, and how students react emotionally to content) may be tracked and reported to teachers and course designers, for use in better informing the design of their classes. For example, such a report may be generated by server 100 and conveyed to a course designer via a user device 120. Content items having, e.g., few upvotes or aggregate student reactions failing to meet threshold levels of positivity may then be prioritized for supplementation, replacement or removal prior to administering future iterations of the course.

Unbundled Textbooks and Course Marketplaces

Traditionally, authors and publishers develop comprehensive textbooks containing source material teaching a body of subject matter on which a course may be based. Teachers select a textbook, and request that students purchase the textbook, at significant expense. Thus, educational course materials are typically sourced and purchased in a bundled fashion. Teachers may use only a portion of a textbook for a given course, such that students end up purchasing content not needed. Teachers may also prefer different subsections of content from different textbooks, thereby either requiring the teacher to force students to purchase multiple textbooks (at even greater expense), or sacrifice optimal course materials by comprising on a single text.

By contrast, embodiments described herein provide a platform for unbundling of educational content. In designing course maps, teachers can select and license for their class, portions of content (organized into specific nodes, or bundles of one or more nodes), rather than entire textbooks. A platform administrator can then act as a publisher and/or distributor of such content, providing a course content repository (such as an online marketplace) from which course administrators can select content to be made available for incorporation into a course map. Content nodes within a selected course content node bundle may then be linked with other nodes in a course map by a course administrator, thereby allowing course administrators to easily supplement an existing course map (e.g. based on new questions from course participants, or supplementing course content nodes prepared from other sources), and/or create a new course map from selected content.

Embodiments described herein may also provide a new and improved distribution platform for short form educational content. Currently, teachers frequently select a single comprehensive textbook for a course to minimize student expense and administrative overhead. High quality topic-specific content that is not bundled into a comprehensive course text may have limited opportunities for distribution. However, in frameworks described herein, such topic-specific content can be easily and dynamically bundled in various combinations by a course creator, with different course map nodes aggregating content from different sources.

Some embodiments of the platform described herein may also include a marketplace component. Course designers may offer to license course-maps for use by others. Similarly, custom course map-specific textbooks may be published comprising aggregated source materials associated with nodes in a particular course map. Such mechanisms provide content creators, course leaders and students with high degrees of flexibility in creating, distributing and consuming highly-customized educational content.

Learner Assessments

Assessment is critical for helping others understand whether a student has learned anything from their experience. However, traditional techniques for assessing learners (such as quizzes and examinations) may be perceived by learners as scary, intimidating, or judgmental. However, other ways of assessing learners can be implemented by embodiments of the learning platform described herein, in order to accurately represent what a learner has learned for the learner herself, and for third-parties.

Learners can be assessed using one or more of the following assessment mechanisms: (1) Tracking how the learner interacts with the map and categorizing that interaction; (2) Recording and assessing the questions they ask; (3) Recording and assessing the long-form content the learner writes in response to open questions; (3) Critiquing the content the learner writes and assessing their responses to our critiques; and/or (4) Tracking the learner's self-defined goals and their own assessment of whether they have achieved those goals. Mechanisms implementing one or more of these assessment techniques can be embodied in application logic 102, evaluating interactions between client devices 120 with server 100.

These methods of assessment may be particularly important to the extent that companies, recruiters, and educational institutions are all beginning to recognize so called ‘soft skills’ as important predictors of success for their students and employees. Techniques described herein can be utilized to assess such soft skills, efficiently and at scale.

In particular, learners can be assessed based on: their preferred method of learning—exploratory, broad overview, deep dive, goal focused, etc.; their recognition and ability to handle nuance in complex arguments; their ability to synthesize their own opinions from a diverse range of sources, or to put to use newly gained skills or novel uses; their ability to phrase clear and thoughtful questions; their ability to discuss a topic without unnecessarily attacking or deriding other opinions (i.e. their ability to hold civil discourse); their ability to explain how they know what they know; their ability to take criticism and use it to improve their own work; their ability to articulate goals for their work and recognize when they have achieved that goal; and their ability to improvise in the face of difficulty.

Rather than assessing at a single end point of a course (as is common for traditional examinations), learners can be assessed continuously throughout the learning experience, taking full advantage of the user event tracking available to server 100 as an online platform.

Details of certain embodiments of methods listed above are as follows:

Tracking how the learner interacts with the map and categorizing that interaction. Server 100 records each action the learner takes while interacting with the map (e.g. using client devices 120). These map interaction attributes may include, without limitation: which nodes the user opens, which questions they select as being of interest, and emoji-based or text reactions to content, how long they interact with the map during a setting, and others. This data can be used to derive a learner-specific-map that details the learner's interactions with the overall map. This learner-specific-map is included as part of the course participant assessment. This data can also be used to categorize the learner using machine learning algorithms for categorization. Based on this categorization, the learner is assigned one or more labels describing their interaction. EG methodical, exploratory, depth-focused, goal-focused, survey-focused, etc. The learner may also be assigned a rating associated with each of these labels. EG-30 out of 40 for methodical, 15 out of 40 for exploratory, etc.

Recording and assessing the questions they ask. Every new question (IE a question that was not pre-curated by the map team) asked by the learner is recorded. These questions can then be reviewed (e.g. by service provider employees or agents) and rated based on a set of metrics including question clarity, frankness, and a number of other measures. Each question's ratings are recorded in database 104, and a graph is produced showing the learner's improvement over time. In this way, both question-asking ability and the learner's rate of learning can be evaluated.

Recording and assessing the long-form content the learner writes in response to open questions. Every custom response the learner writes in answer to an unanswered question documented on the map—whether their own or someone else's—is recorded for assessment. These custom responses can then be reviewed (e.g. by service provider employees or agents) and rated based on a similar set of metrics as those indicated above. These ratings are also recorded in database 104 and again used to build graphs showing overall rating and improvement over time. A single example of the user's writing that best represents the user's current skill level can be automatically included in the assessment as a sample.

Critiquing the content the learner writes and assessing their responses to critiques. Service provider employees or agents ask the learner questions about the content they have produced. The learner then responds to those questions with modifications to or improvements on their initial content, just like a traditional editing process, but with all versions and all critiques recorded by server 100. The service provider can then review the learner's responses and again rate them based off of a standard set of metrics. Again, this information is documented and displayed as a graph of improvement over time.

Tracking the user's self-defined goals and their own assessment of whether they have achieved those goals. The user specifies their goal for a course at the beginning and optionally changes their goal during the course. When they complete the course they are asked to summarize whether they achieved their goal or not in any way they see fit—video, writing, photograph, etc. Service provider employees or agents can then review the learner's responses and again rate them based off of a standard set of metrics. Again, this information is documented and displayed as a graph of improvement over time.

In all of the above steps, the learner's content may anonymously be shown to other learners interacting with the same course and the questions and reactions of those other learners may be used to automatically rate the work of this learner. In this way, assessments can be crowd-sourced, or service provider assessments can be augmented with crowd-sourced assessments.

Using the above ratings, concise ‘dashboards’ can be generated that summarize an individual learner and work as an equivalent of a diploma. This dashboard would be shareable with future employers and would include summaries of learning styles, rates of learning, question and content quality, and major areas of interest as indicated by the learner's own goals and questions.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A method for developing and administering an inquiry-based educational course to course participants, comprising the steps of:
building a course map with linked nodes, the nodes representing course content, each interconnected by one or more links which represent a natural next question for course participants, comprising:
an initial course map building phase, comprising:
articulating one or more questions defining a course topic;
seeding and linking nodes of the initial course map with questions and content from at least one of evaluating the test participant group's reactions to the one or more questions defining the course topic, information from course experts, and information from a course designer;
testing the seeded initial course map, comprising:
evaluating responses from a test user to the node content linked by natural next questions; and
adjusting the seeded initial course map based on the test user's responses, to form the course map; and
upon approval, providing course participants with access to the course map;
rendering, for each course participant, on a personal electronic device display screen, at least a portion of the course map, including at least one of a first node question, a link to a linked adjacent node representing a natural next question associated with the first node and to which the linked adjacent node is responsive;
in response to a selection of a first link by a course participant, displaying content associated with the linked adjacent node on the participant's personal electronic device;
querying the course participant for input of a course participant question responsive to the linked adjacent node; and
comparing the course participant's inputted question to course map link questions, and if there is correspondence with an existing link, displaying a content associated with a second linked node, and if there is not a correspondence with an existing link, evaluating the course participant's inputted question for addition to the course map.
